(19) United States
(12) Patent Application Publication
(10) Pub. No.: US 2026/0203593 A1
(43) Pub. Date: Jul. 16, 2026

(54) METHOD AND APPARATUS FOR BLACK-BOX OPTIMIZATION USING DUAL CRITIC MODELS

(71) Applicant: ELECTRONICS AND TELECOMMUNICATIONS RESEARCH INSTITUTE, Daejeon (KR)

(72) Inventors: Yongjin Lee, Daejeon (KR); Moonyoung Chung, Daejeon (KR)

(21) Appl. No.: 19/448,691

(22) Filed: Jan. 14, 2026

(30) Foreign Application Priority Data
Jan. 15, 2025 (KR) 10-2025-0006110
Dec. 11, 2025 (KR) 10-2025-0195947

(51) Int. Cl. G06N 3/092

(52) U.S. Cl. CPC G06N 3/092

(57) ABSTRACT

Disclosed herein are a method and apparatus for black-box optimization, which optimize input (or setting) variables of complex systems using dual critic models. The method for black-box optimization includes storing a data set composed of pairs of input variable values and evaluation values for the input variable values (ψ, R(ψ)), configuring a training data pair ((ψ, ψ′), ΔR(ψ, ψ′)) that represents a relative evaluation difference ΔR(ψ, ψ′) between a reference input variable value ψ and a selected input variable value ψ′ (which is different from the reference input variable value) in the data set, training a differentiable dual critic model C(ψ, ψ′) that predicts a relative difference in evaluation value between two input variable values using the training data pair ((ψ, ψ′),ΔR(ψ, ψ′)), calculating a gradient for the reference input variable value ψ using the trained dual critic model, and updating the reference input variable value ψ using the calculated gradient.

### CROSS-REFERENCE TO RELATED APPLICATIONS

The present application claims priority to Korea Patent Application No. 10-2025-0006110, filed Jan. 15, 2025 and Korea Patent Application No. 10-2025-0195947, filed Dec. 11, 2025, the entire contents of which is incorporated herein for all purposes by this reference.

### BACKGROUND

### 1. Technical Field

The present disclosure relates to a method and apparatus for black-box optimization, and more particularly, to a method and apparatus for black-box optimization, which optimize input (or setting) variables of complex systems using differentiable dual critic models.

### 2. Description of Related Art

Black-box optimization is a method of optimizing the performance of a target system using only input and output values without knowing the internal structure, mathematical expression, differential availability, etc., of the system. Examples of representative techniques for the same include evolutionary algorithms, Bayesian optimization, reinforcement learning (RL), and differentiable surrogate model utilization.

Black-box optimization utilizing surrogate models is a technique for performing optimization by generating a model that approximates the behavior of a target system. A surrogate model is used on behalf of an original system in the process of adjusting the input or setting variables of a target system to obtain output results from the system that meet user-specified performance objectives. This method is effectively applicable even when the original system has high computational costs or its internal structure is unknown.

The most basic of the surrogate model techniques is to utilize a Taylor series expansion. This method is applicable only when the mathematical structure of the target system is known and differentiable.

However, it has limitations in optimization because accurate approximation is difficult in complex nonlinear systems even if the target system is defined as a differentiable mathematical function.

Meanwhile, it is also widely known that a Gaussian process is used as a surrogate model for Bayesian optimization. This method has a great advantage in that it is applicable even when a target system is not defined as a differentiable mathematical function. However, it may have rapidly increasing computational costs as the dimensionality of input (or setting) variables increases and may be difficult to apply in large variable spaces.

To overcome these limitations, there have been proposed a surrogate model utilizing a deep-neural-network-based generative model, and an optimization method based on the same. The deep-neural-network-based generative model is suitable for approximating complex nonlinear systems by learning the relationship between inputs and outputs, and has an advantage of being differentiable. Utilizing the differentiability of the generative model is able to apply gradient descent or gradient ascent, which is evaluated to perform optimization efficiently even when there are many input (or setting) variables compared to other methods.

However, if there are too many input (or setting) variables, it is difficult to accurately estimate the correlation between variables and eliminate redundancy. This may still limit the scope of application of the generative-model-based optimization method.

The conventional surrogate model technique works in the following procedure. First, a deep-neural-network-based generative model is trained as a surrogate model. Then, input (or setting) variable values are input into the surrogate model to obtain an output value. After evaluating how well the output value of the surrogate model obtained in this way meets user-specified performance objectives, the input (or setting) variable values are adjusted based thereon to derive results more suitable for the user-specified performance objectives.

Here, the important point is that the evaluation is performed based on the output value of the surrogate model, rather than directly utilizing the actual output value of the original system to evaluate whether to meet the performance objectives.

Therefore, if the surrogate model does not accurately mimic the behavior or output of the original target system, the reliability and effectiveness of the optimization results may be significantly reduced. The surrogate model must accurately mimic the behavior or output of the original target system in order to effectively optimize the original system.

In this regard, the limitations of the surrogate model using the generative model can be summarized as follows.

First, there are data and computational cost issues.

Accurately mimicking the behavior of a target system requires large amounts of data and high computational costs. The quality of the surrogate model is likely to deteriorate, especially in situations where it is difficult or limited to collect data from the target system. This also negatively impacts optimization performance.

In addition, there are limitations to the approximation of complex systems.

Despite the high expressiveness of deep neural networks, there are still limitations to the perfect approximation of individual behaviors of complex systems. It is possible that this will not achieve expected results in actual optimization.

### CITATION LIST

### Patent Document

(Patent Document 1) Korean Patent Application Publication No. 10-2024-0002530 (Jan. 5, 2024), entitled “METHOD AND SYSTEM FOR RANDOM INPUT SAMPLING OPTIMIZED FOR EXPLANATION OF BLACK-BOX MODELS”

### SUMMARY

Accordingly, an object of the present disclosure is to provide a method and apparatus for black-box optimization, which optimize input (or setting) variables of complex systems using dual critic models.

Another object of the present disclosure is to provide a method and apparatus for black-box optimization, which optimize input (or setting) variables of systems using differentiable dual critic models without surrogate model construction.

A further object of the present disclosure is to provide a method and apparatus for black-box optimization, which are capable of performing optimization of complex black-box systems by directly learning a difference of relative performance between input (or setting) variables and thus updating input values based on gradients.

In accordance with an aspect of the present disclosure, there is provided a method for black-box optimization, which is intended to optimize a target system in the form of a black box. The method for black-box optimization includes storing a data set composed of pairs of input variable values and evaluation values for the input variable values (ψ, R(ψ)), configuring a training data pair ((ψ, ψ′), ΔR(ψ, ψ′)) that represents a relative evaluation difference ΔR(ψ, ψ′) between a reference input variable value ψ and a selected input variable value ψ′ (which is different from the reference input variable value) in the data set, training a differentiable dual critic model that predicts a relative difference in evaluation value between two input variable values using the training data pair, calculating a gradient for the reference input variable value ψ using the trained dual critic model, and updating the reference input variable value ψ using the calculated gradient.

The target system in the form of a black box may include at least one of a system whose internal structure or operating principle is not disclosed, a system that is not able to directly calculate a differential value or internal gradient with respect to an input value, a system that is able to only observe an output value according to an input value, and a system that is any one of a function, a simulation model, a deep learning process, a chemical process system, and a physical system.

The method for black-box optimization may further include generating a set of neighboring input variable values

$${\{ {ψ}_{i} \}}_{i = 1}^{N}$$

based on the reference input variable value ψ, wherein N represents the number of neighboring input variable values generated, obtaining each output value

$${\{ {y}_{i} \}}_{i = 0}^{N}$$

by entering the neighboring input variable values

$${\{ {ψ}_{i} \}}_{i = 1}^{N}$$

of ψ into the target system, and calculating an evaluation value

$${\{ R ( {ψ}_{i} ) \}}_{i = 0}^{N}$$

corresponding to each input variable value by entering the output value

$${\{ {y}_{i} \}}_{i = 0}^{N}$$

into an evaluation function R(·).

The calculating a gradient for the reference input variable value ψ comprises differentiating the dual critic model C(ψ, ψ′) with respect to ψ.

The calculating a gradient for the reference input variable value ψ further comprises calculating M gradients, the number of which is the number of selected input variable values ψ, and calculating a final gradient using an average of the M gradients.

The dual critic model may satisfy C(ψ, ψ′)=−C(ψ′, ψ).

The selected input variable value ψ′ may satisfy d(ψ, ψ′ᵢ)<ϵ_{ψ}, where the d is a measure of the distance between vectors and the ϵ_{ψ} is a user-set threshold value.

The selected input variable value ψ′ may satisfy d(R(ψ), R(ψ′ᵢ))<ϵ_{ψ}, where the d is a measure of the distance between vectors and the ϵ_{ψ} is a user-set threshold value.

The set of neighboring input variable values

$${\{ {ψ}_{i} \}}_{i = 1}^{N}$$

may be generated in an embedding space.

In accordance with another aspect of the present disclosure, there is provided an apparatus for black-box optimization, which is intended to optimize a target system in the form of a black box. The apparatus for black-box optimization includes a data storage unit configured to store a data set composed of pairs of input variable values and evaluation values for the input variable values (ψ, R(ψ)), a training data configuration unit configured to configure a training data pair ((ψ, ψ′), ΔR(ψ, ψ′)) that represents a relative evaluation difference ΔR(ψ, ψ′) between a reference input variable value ψ and a selected input variable value ψ′ (which is different from the reference input variable value) in the data set, a training unit configured to train a differentiable dual critic model that predicts a relative difference in evaluation value between two input variable values using the training data pair, a gradient calculation unit configured to calculate a gradient for the reference input variable value ψ using the trained dual critic model, an input variable update unit configured to update the reference input variable value ψ using the calculated gradient, and a control unit configured to control the data storage unit, the training data configuration unit, the gradient calculation unit, and the input variable update unit.

The target system in the form of a black box may include at least one of a system whose internal structure or operating principle is not disclosed, a system that is not able to directly calculate a differential value or internal gradient with respect to an input value, a system that is able to only observe an output value according to an input value, and a system that is any one of a function, a simulation model, a deep learning process, a chemical process system, and a physical system.

The apparatus for black-box optimization may further include a neighboring input variable generation module configured to generate a set of neighboring input variable values

$${\{ {ψ}_{i} \}}_{i = 1}^{N}$$

based on the reference input variable value ψ, wherein N represents the number of neighboring input variable values generated, an output value acquisition unit configured to obtain each output value

$${\{ {y}_{i} \}}_{i = 0}^{N}$$

by entering the neighboring input variable values

$${\{ {ψ}_{i} \}}_{i = 1}^{N}$$

of ψ into the target system; and an evaluation value calculation unit configured to calculate an evaluation value

$${\{ R ( {ψ}_{i} ) \}}_{i = 0}^{N}$$

corresponding to each input variable value by entering the output value

$${\{ {y}_{i} \}}_{i = 0}^{N}$$

into an evaluation function R(·).

The neighbor input variable generation module may randomly sample from Gaussian distribution or uniform distribution whose mean is set as the initial value ψ₀.

The training unit may train the dual critic model using a loss function based on a difference between the predicted value output C(ψ, ψ′) through the dual critic model and the relative evaluation difference ΔR(ψ, ψ′).

The dual critic model may satisfy C(ψ, ψ′)=−C(ψ′, ψ).

The selected input variable value ψ′ may satisfy d(ψ, ψ′ᵢ)<Ep, where the d is a measure of the distance between vectors and the ϵ_{ψ} is a user-set threshold value.

The selected input variable value ψ′ may satisfy

$$d ( R ( ψ ) , R ( {ψ}_{i}^{′} ) ) < {ϵ}_{R} ,$$

where the d is a measure of the distance between vectors and the ϵ_{R} is a user-set threshold value.

The set of neighboring input variable values

$${\{ {ψ}_{i} \}}_{i = 1}^{N}$$

may be generated in an embedding space.

In accordance with a further aspect of the present disclosure, there is provided a computer-readable recording medium having a program stored thereon for causing a computer to execute a method for black-box optimization. The method for black-box optimization includes storing a data set composed of pairs of input variable values and evaluation values for the input variable values (ψ, R(ψ)), configuring a training data pair ((ψ, ψ′), ΔR(ψ, ψ′)) that represents a relative evaluation difference ΔR(ψ, ψ′) between a reference input variable value ψ and a selected input variable value ψ′ (which is different from the reference input variable value) in the data set, training a differentiable dual critic model that predicts a relative difference in evaluation value between two input variable values using the training data pair, calculating a gradient for the reference input variable value ψ using the trained dual critic model, and updating the reference input variable value p using the calculated gradient.

### BRIEF DESCRIPTION OF THE DRAWINGS

The above and other objects, features and other advantages of the present disclosure will be more clearly understood from the following detailed description taken in conjunction with the accompanying drawings, in which:

FIG. 1 is a block diagram illustrating an apparatus for black-box optimization using dual critic models (hereinafter, referred to as “optimization apparatus”) according to an embodiment of the present disclosure;

FIG. 2 is a detailed block diagram illustrating the training unit of FIG. 1;

FIG. 3 is a flow diagram illustrating a method for black-box optimization using dual critic models (hereinafter, referred to as “optimization method”) according to an embodiment of the present disclosure;

FIG. 4 is a block diagram illustrating how to construct a dual critic model using a deep neural network according to an embodiment of the present disclosure;

FIG. 5 illustrates an exemplary critic model implemented with PyTorch according to an embodiment of the present disclosure;

FIG. 6 is a block diagram illustrating an operation of a decoder module according to an embodiment of the present disclosure; and

FIG. 7 is a diagram for explaining a computing environment including a computing device according to an embodiment of the present disclosure.

### DETAILED DESCRIPTION

In order to fully understand the present disclosure, the operational advantages of the present disclosure, and the objects achieved by the practice of the present disclosure, reference should be made to the accompanying drawings for illustrating preferred embodiments of the present disclosure and the contents described in the accompanying drawings.

Hereinafter, exemplary embodiments of the present disclosure will be described in detail with reference to the accompanying drawings. The present disclosure may, however, be embodied in different forms and should not be construed as being limited to the embodiments set forth herein. In order to clearly illustrate the present disclosure in the drawings, parts irrelevant to the description may be omitted, and like reference numerals refer to like elements throughout the specification.

It should be understood that an embodiment and the terms used herein are not intended to limit the technology described in the present disclosure to the specific embodiments, but the present disclosure encompasses various modifications, equivalents, and/or substitutes of the embodiment.

In certain embodiments, detailed descriptions of constructions or functions well known in the art may be omitted to avoid obscuring appreciation of the disclosure by a person of ordinary skill in the art.

In connection with the description of the drawings, similar reference numerals may be used for similar components.

The singular forms “a”, “an” and “the” are intended to include the plural forms as well, unless context clearly indicates otherwise.

In this document, an expression such as “A or B” or “at least one of A and/or B” may include all possible combinations of the items listed together.

It will be understood that when a component (e.g., first component) is referred to as being “(functionally or communicatively) connected” or “joined” to another component (e.g., second component), that component may be directly connected to the other component or may be connected through a component (e.g., third component) to the other component.

As used herein, the singular forms “a”, “an” and “the” are intended to include the plural forms as well, unless context clearly indicates otherwise. In the present disclosure, the terms “consisting of” or “comprising” should not be construed to necessarily include all of the various components or steps described in the specification, but rather to mean that some of the components or steps may not be included or that additional components or steps may be further included.

In the following embodiments, an input variable(s) represents an input (or setting) variable(s) of a target system in the form of a black box, and may also be used to refer to the value(s) of the input (or setting) variable(s) if there is no ambiguity in meaning. In addition, the input (or setting) variable may contain a multidimensional vector having multiple values.

In addition, the input variable may also be used to refer to the value of the input (or setting) variable if there is no ambiguity in meaning. A setting variable(s) set by a user is conceptually included in the input variable(s), but in the following embodiments, the setting variable(s) is referred to as an input variable(s).

In addition, among the input variables, the input variable that is currently subject to update will be called a reference input variable ψ.

In this specification, the target system may refer to a system in the form of a black box that provides an output value corresponding to an input value (if it is given), but whose internal structure or operating principle is unknown.

The target system in the form of a black box may include at least one of the following systems:
1) a system whose internal structure or operating principle is not disclosed;
2) a system that is not able to directly calculate a differential value or internal gradient with respect to an input value;
3) a system that is able to only observe an output value according to an input value; and
4) a system that is any one of a function, a simulation model, a deep learning process, a chemical process system, and a physical system.

The following embodiment will describe how to automatically search for a reference input variable value ψ) to output a result that meets a user-specified performance objective as closely as possible by utilizing a differentiable deep-neural-network-based dual critic model.

For example,
in the problem of finding the maximum or minimum value of the given function such as y=f(x),
ψ corresponds to an input variable x, and the target system corresponds to a function f(·).

In the case of hyperparameter tuning in the deep learning,
ψ may be a hyperparameter such as a learning rate and a batch size, and the target system may correspond to a learning process including a deep neural network model.

In the case of finding the optimal combination of temperature and pressure in the chemical process,
ψ may correspond to a set temperature and pressure, and the target system may correspond to a chemical process itself.

In the problem of optimizing simulation setting values to improve simulation accuracy,
ψ may correspond to a simulation setting value or input value, and the target system may refer to a simulation model, a simulation process, or a simulator.

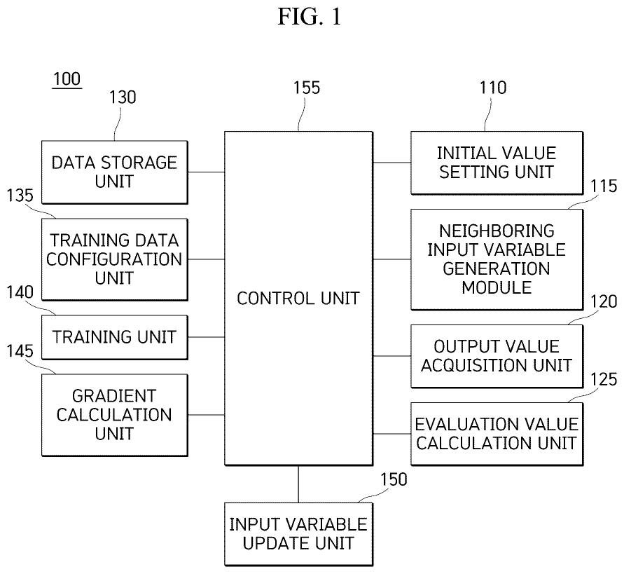

FIG. 1 is a block diagram illustrating an apparatus for black-box optimization using dual critic models (hereinafter, referred to as “optimization apparatus”) according to an embodiment of the present disclosure.

As illustrated in the drawing, the optimization apparatus, which is designated by reference numeral 100, may include an initial value setting unit 110, a neighboring input variable generation module 115, an output value acquisition unit 120, an evaluation value calculation unit 125, a data storage unit 130, a training data configuration unit 135, a training unit 140, a gradient calculation unit 145, an input variable update unit 150, and a control unit 155.

The initial value setting unit 110 may set an initial value ψ₀ of a reference input variable value.

The initial value ψ₀ may be selected randomly, may be an appropriate value selected based on user experience, or may be a value obtained by searching for other optimization methods previously.

The neighboring input variable generation module 115 may generate a set of neighboring input variable values

$${\{ {ψ}_{i} \}}_{i = 1}^{N}$$

based on the initial value ψ₀. Here, N represents the number of neighboring input variable values generated. For example, N may be a natural number such as 10 or 100.

The output value acquisition unit 120 may obtain each output value

$${\{ {y}_{i} \}}_{i = 0}^{N}$$

by entering the neighboring input variable values

$${\{ {ψ}_{i} \}}_{i = 1}^{N}$$

of ψ₀ into a target system. The output of the target system may be a single value or multiple values. In other words, yᵢ may be a scalar or a multidimensional vector.

The output value refers to the result data directly calculated by the target system when a specific input variable value is entered into the target system. The output value may be a scalar value, a multidimensional vector, or structured data.

The evaluation value calculation unit 125 may calculate an evaluation value

$${\{ R ( {ψ}_{i} ) \}}_{i = 0}^{N}$$

usign the output value

$${\{ {y}_{i} \}}_{i = 0}^{N} .$$

The evaluation value

$${\{ R ( {ψ}_{i} ) \}}_{i = 0}^{N}$$

is a quantified indicator to indicate how well the output value

$${\{ {y}_{i} \}}_{i = 0}^{N}$$

meets a user-set optimization objective, and may be the output value itself or a value calculated from the output value through a predefined evaluation function R(·). The derived evaluation value may be a single scalar value or a vector value containing multiple indicators.

The evaluation value calculation unit 125 may calculate the evaluation value

$${\{ R ( {ψ}_{i} ) \}}_{i = 0}^{N}$$

corresponding to each input variable value by entering the output value

$${\{ {y}_{i} \}}_{i = 0}^{N}$$

into the evaluation function R(·). If the input variable value ψᵢ is evaluated in various ways, R(ψᵢ) may be a multidimensional vector. Here, i is an index corresponding to each input variable.

The data storage unit 130 may store a data set composed of pairs of input variable values and evaluation values for the input variable values (ψ, R(ψ)).

The training data configuration unit 135 may configure a training data pair ((ψ, ψ′), ΔR(ψ, ψ′)) that represents a relative evaluation difference ΔR(ψ, ψ′) between a reference input variable value ψ and a selected input variable value ψ′ (which is different from the reference input variable value) in the data set.

The training unit 140 may train a differentiable dual critic model that predicts the difference in relative evaluation value between two input variable values using the training data pair ((ψ, ψ′), ΔR(ψ, ψ′)).

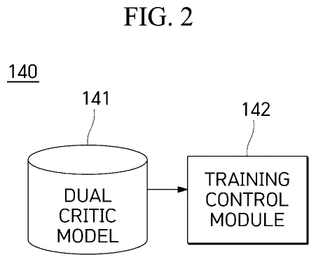

FIG. 2 is a detailed block diagram illustrating the training unit of FIG. 1.

As illustrated in the drawing, the training unit 140 may include a dual critic model 141 and a training control module 142.

The dual critic model 141 is a differentiable model and may be configured to have anti-symmetric properties.

The training control module 142 may train the dual critic model 141 so that the predicted value output through the dual critic model 141 is approximated to the actual result value.

The dual critic model 141 will be described in detail later.

Referring back to FIG. 1, the gradient calculation unit 145 may use the trained dual critic model 141 to calculate a gradient for the reference input variable value ψ.

The input variable update unit 150 may use the calculated gradient to update the reference input variable value ψ.

The control unit 155 may control the initial value setting unit 110, the neighboring input variable generation module 115, the output value acquisition unit 120, the evaluation value calculation unit 125, the data storage unit 130, the training data configuration unit 135, the training unit 140, the gradient calculation unit 145, and the input variable update unit 150 as a whole.

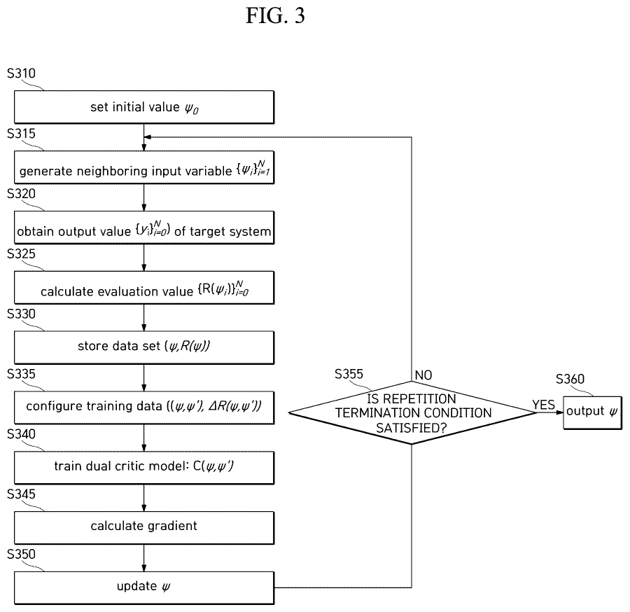

FIG. 3 is a flow diagram illustrating a method for black-box optimization using dual critic models (hereinafter, referred to as “optimization method”) according to an embodiment of the present disclosure.

The optimization apparatus 100 may set an initial value ψ₀ of a reference input variable value (S310).

The initial value ψ₀ may be selected randomly, may be an appropriate value selected based on user experience, or may be a value obtained by searching for other optimization methods previously.

The optimization apparatus 100 may generate a set of neighboring input variable values

$${\{ {ψ}_{i} \}}_{i = 1}^{N}$$

based on the initial value ψ₀ (S315). Here, N represents the number of neighboring input variable values generated. For example, N may be a natural number such as 10 or 100.

The optimization apparatus 100 may also generate the set of neighboring input variable values

$${\{ {ψ}_{i} \}}_{i = 1}^{N}$$

through random sampling by setting the mean of multidimensional Gaussian distribution or uniform distriction as the initial value ψ₀.

The optimization apparatus 100 may enter the neighboring input variable values

$${\{ {ψ}_{i} \}}_{i = 1}^{N}$$

of ψ₀ into a target system to drive the target system and obtain an output value

$${\{ {y}_{i} \}}_{i = 0}^{N}$$

for each of the input variable values (S320). The output of the target system may be a single value or multiple values. In other words, yᵢ may be a scalar or a multidimensional vector.

The optimization apparatus 100 may calculate an evaluation value

$${\{ R ( {ψ}_{i} ) \}}_{i = 0}^{N}$$

corresponding to each input variable value by entering the output value

$${\{ {y}_{i} \}}_{i = 0}^{N}$$

into an evaluation function R(·) (S325). If the input variable value ψᵢ is evaluated in various ways, R(ψᵢ) may be a multidimensional vector. Here, i is an index corresponding to each input variable.

The evaluation value may be calculated in various forms depending on the target system.

For example, in the problem of function optimization to find the maximum or minimum value of the function output, the result (or output) value yᵢ itself of the target system may be an evaluation value R(ψᵢ) for ψᵢ.

In the case of hyperparameter tuning in the deep learning, the prediction accuracy or classification accuracy of the deep learning model may be an evaluation value R(ψᵢ) for ψᵢ.

In the case of finding the optimal combination of temperature and pressure in the chemical process, the purity or yield of the final produced compound may be an evaluation value R(ψᵢ) for ψᵢ.

In the case of simulation accuracy improvement, the error value between simulation results and actual observations may be an evaluation value R(ψᵢ) for ψᵢ.

The optimization apparatus 100 may store a data set composed of pairs of input variable values and evaluation values for the input variable values (ψ, R(ψ)) (S330).

The optimization apparatus 100 may configure training data by selecting data for training a dual critic model 141 from the data set (S335).

The process of configuring the training data is as follows.

First, an initial value ψ₀ and a neighboring

$${ψ}_{i}^{′}$$

are selected. The input variable

$${ψ}_{i}^{′}$$

selected in this process satisfies the condition of the following Equation 1.

$$d ( {ψ}_{0} , {ψ}_{i}^{′} ) < {ϵ}_{ψ} \qquad [ Equation 1 ]$$

where d is a measure of the distance between vectors (e.g., Euclidean distance), and ϵ_{ψ} is a threshold value set by the user. In other words, the optimization apparatus 100 may select an input variable

$${ψ}_{i}^{′}$$

whose distance from ψ₀ is less than ϵ_{ψ}.

Alternatively, the optimization apparatus 100 may select

$${ψ}_{i}^{′}$$

having an evaluation value similar to the evaluation value of ψ₀, as in the following Equation 2.

$$d ( R ( {ψ}_{0} ) , R ( {ψ}_{i}^{′} ) ) < {ϵ}_{R} \qquad [ Equation 2 ]$$

where d is a measure of the distance between vectors (e.g., Euclidean distance), and ϵ_{R} is a threshold value set by the user.

The optimization apparatus 100 may configure the training data for training the dual critic model based on the selected data in the following form.

$$( ( ψ , {ψ}^{′} ) , Δ R ( ψ , {ψ}^{′} ) )$$

Here, (ψ, ψ′) represents any combination of previously selected input variable values, and ΔR(ψ, ψ′) refers to a relative evaluation difference between those input variable values. ΔR(ψ, ψ′) may be expressed as in the following Equation 3.

$$Δ R ( ψ , {ψ}^{′} ) = R ( ψ ) - R ( {ψ}^{′} ) \qquad [ Equation 3 ]$$

The optimization apparatus 100 may train a differentiable dual critic model 141 that predicts the difference in relative evaluation value between two input variable values using the training data pair ((ψ, ψ′), ΔR(ψ, ψ′)) (S340).

According to the embodiment of the present disclosure, the optimization apparatus 100 may train the dual critic model 141 constructed from a deep neural network model. C(ψ, ψ′) may refer to a predicted value for the difference in evaluation value between two input variables output from the dual critic model 141.

The dual critic model 141 may be trained to predict the difference in evaluation value between two input variables, a reference input variable ψ) and a selected input variable ψ′, upon receiving the two input variables.

The dual critic model 141 may be trained so that the difference between its output value and the actual evaluation value is approximated: C(ψ, ψ′)≈ΔR(ψ, ψ′).

The dual critic model 141 may be constructed and trained from the deep neural network model. It is possible to apply commonly used deep learning techniques (e.g., gradient-descent-based optimization). If R(·) has a scalar output value, and thus ΔR(ψ, ψ′) also has a scalar value, i.e., if the input (or setting) variables are evaluated in one way, the square of the difference may be used as a training loss as follows.

$${( C ( ψ , {ψ}^{′} ) - Δ R ( ψ , {ψ}^{′} ) )}^{2}$$

Alternatively, the absolute value of the difference may be used as a training loss as follows.

$$\vert C ( ψ , {ψ}^{′} ) - Δ R ( ψ , {ψ}^{′} ) \vert$$

If R(·) has a multidimensional vector value, and thus ΔR(ψ, ψ′) also has a multidimensional vector value, i.e., if the input variables are evaluated in various ways, the dual critic model C(ψ, ψ′) may be trained by utilizing the squared Euclidean distance below as a loss for training.

$${‖ C ( ψ , {ψ}^{′} ) - Δ R ( ψ , {ψ}^{′} ) ‖}_{2}^{2}$$

The optimization apparatus 100 may use the trained dual critic model 141 to calculate a gradient for the reference input variable value ψ (S345).

The optimization apparatus 100 may calculate the gradient using the trained dual critic model 141 as in the following Equation 4, to adjust the reference input variable ψ) or the initial value ψ₀. For convenience of explanation, it is assumed that C(ψ, ψ′) has a single output value.

$${\{ {∇}_{ψ = {ψ}_{0}} C ( ψ , {ψ}^{′} = {ψ}_{j}^{′} ) \}}_{j = 1}^{M} \qquad [ Equation 4 ]$$

where

$${\{ {ψ}_{j}^{′} \}}_{j = 1}^{M}$$

refers to any M surrounding values of ψ₀, and may be configured as follows:
training data selected in step S335;
randomly sampled values at 200 of step S315; or
a union of the variable values generated by the above two methods.

The optimization apparatus 100 sets the value of the variable ψ′ corresponding to the second input of the dual critic model 141 C(ψ, ψ′) to

$${\{ {ψ}_{j}^{′} \}}_{j = 1}^{M} ,$$

and differentiates the dual critic model 141 C(ψ, ψ′) based on the first input variable ψ. Then, the optimization apparatus 100 calculates a gradient ∇_{ψ=ψ}_{₀}C(ψ, ψ′) at ψ₀. M gradients are calculated using any M surrounding values.

If C(ψ, ψ′) has multiple output values, it may be converted into a single-value form Ĉ(ψ, ψ′) using a combination weight λⱼ preset by the user as in the following Equation 5.

$$\hat{C} ( ψ , {ψ}^{′} ) = {\sum }_{j} {λ}_{j} {C ( ψ , {ψ}^{′} )}_{j} \qquad [ Equation 5 ]$$

where C(ψ, ψ′)ⱼ represents the jth output value of C(ψ, ψ′). The size of the absolute value of λⱼ is set depending on the importance of the evaluation method. The gradient calculation method described above may be applied to Ĉ(ψ, ψ′) as well.

The optimization apparatus 100 may use the calculated gradient to update the reference input variable value ψ (S350).

The optimization apparatus 100 updates the value of to using the average of the M calculated gradients.

Gradient Descent: if the smaller the evaluation value R(ψ), the better, the value of to is updated by the stochastic gradient descent as in the following Equation 6.

$${ψ}_{0} ← {ψ}_{0} - α \frac{1}{M} {\sum }_{j = 1}^{M} {∇}_{ψ = {ψ}_{0}} C ( ψ , {ψ}^{′} = {ψ}_{j}^{′} ) \qquad [ Equation 6 ]$$

where α represents a learning rate,

$$\frac{1}{M} {\sum }_{j = 1}^{M} {∇}_{ψ = {ψ}_{0}} C ( ψ , {ψ}^{′} = {ψ}_{j}^{′} )$$

represents an average gradient calculated using the surrounding value

$${\{ {ψ}_{j}^{′} \}}_{j = 1}^{M}$$

ψ₀.

Gradient Ascent: if the larger the evaluation value R(ψ), the better, the value of ψ₀ is updated by the stochastic gradient ascent as in the following Equation 7.

$${ψ}_{0} ← {ψ}_{0} + α \frac{1}{M} {\sum }_{j = 1}^{M} {∇}_{ψ = {ψ}_{0}} C ( ψ , {ψ}^{′} = {ψ}_{j}^{′} ) \qquad [ Equation 7 ]$$

where α and

$$\frac{1}{M} {\sum }_{j = 1}^{M} {∇}_{ψ = {ψ}_{0}} C ( ψ , {ψ}^{′} = {ψ}_{j}^{′} )$$

are applied in the same way as the gradient descent.

The optimization apparatus 100 may determine whether the input variable update repetition needs to be terminated (S355).

The optimization apparatus 100 terminates the optimization process if the following conditions are satisfied:
where the preset number of repetitions is exceeded;
where the variation of the value of ψ₀ is small;
where the variation of the value of R(ψ₀) is small; or
where the value of R(ψ₀) reaches a preset value.

If not, the process repeats from step S315.

On the other hand, in steps S335 and S340, it is more effective to train a C(ψ, ψ′) model that predicts the relative difference ΔR(ψ, ψ′) than to train a model C(ψ) that predicts the absolute evaluation value R(ψ) of the single input variable. The reasons are as follows.

First, a common bias may be removed.

The common bias may be contained in the absolute evaluation value. However, when the relative difference ΔR(ψ, ψ′) is calculated, this common bias is canceled out and removed.

$$Δ R ( ψ , {ψ}^{′} ) = ( R ( ψ ) + b ) - ( R ( {ψ}^{′} ) + b )$$

Here, b represents a common bias. When the bias is removed, the critic model does not need to learn the bias, which further improves learning efficiency and prediction accuracy.

Additionally, it has a variance reduction effect.

Since the two input (or setting) variables ψ and ψ′ are neighboring values, it may be assumed that the variance of R(ψ) and the variance of R(ψ′) are equal.

$$Var ( R ( ψ ) ) = Var ( R ( {ψ}^{′} ) ) .$$

Based on this assumption, the variance of ΔR(ψ, ψ′) may be derived as in the following Equation 8.

$$\begin{matrix}Var ( Δ R ( ψ , {ψ}^{′} ) ) = Var ( R ( ψ ) - R ( {ψ}^{′} ) ) \\ = Var ( R ( ψ ) ) + Var ( R ( {ψ}^{′} ) ) - \\ 2 \cdot Cov ( R ( ψ ) , R ( {ψ}^{′} ) ) \\ = Var ( R ( ψ ) ) + Var ( R ( {ψ}^{′} ) ) - \\ 2 \cdot Corr ( R ( ψ ) , R ( {ψ}^{′} ) ) \sqrt{Var ( R ( ψ ) ) \cdot Var ( R ( {ψ}^{′} ) )} \\ = 2 \cdot Var ( R ( ψ ) ) \cdot ( 1 - Corr ( R ( ψ ) , R ( {ψ}^{′} ) ) )\end{matrix} \qquad [ Equation 8 ]$$

Since ψ and ψ′ are neighboring values, it may be assumed that the correlation between R(ψ) and R(ψ′) is very high. In the case of Corr(R(ψ), R(ψ′))>0.5, the variance of ΔR(ψ, ψ′) is smaller than the variance of R(ψ). This means that ΔR(ψ, ψ′) is easier to predict than R(ψ). These results suggest that it is easier to train an evaluation model that predicts relative evaluation values than to train an evaluation model that predicts absolute evaluation values.

On the other hand, a comparison of relative evaluations between two input variable values ΔR(ψ, ψ′) has the following anti-symmetric properties by definition.

$$Δ R ( ψ , {ψ}^{′} ) = R ( ψ ) - R ( {ψ}^{′} ) = - ( R ( {ψ}^{′} ) - R ( ψ ) ) = - Δ R ( {ψ}^{′} , ψ )$$

Therefore, the dual critic model 141 C(ψ, ψ′) that estimates ΔR(ψ, ψ′) may also be configured to have anti-symmetric properties as in the following Equation 9.

$$C ( ψ , {ψ}^{′} ) = - C ( {ψ}^{′} , ψ ) \qquad [ Equation 9 ]$$

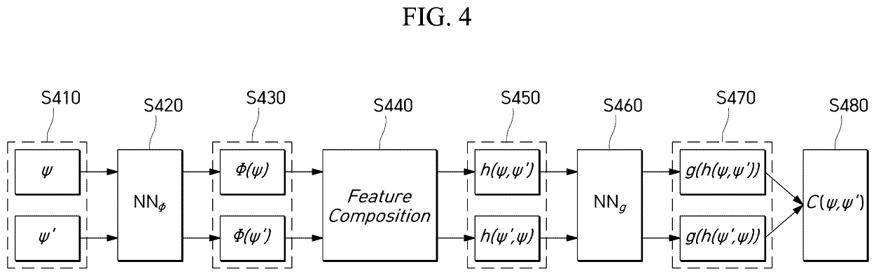

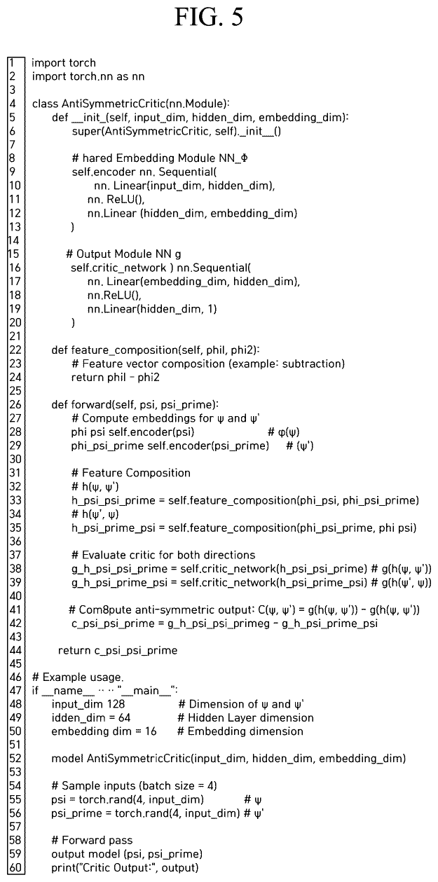

FIG. 4 is a block diagram illustrating how to construct a dual critic model using a deep neural network according to an embodiment of the present disclosure. FIG. 5 illustrates an exemplary critic model implemented with PyTorch according to an embodiment of the present disclosure.

S410 represents two input variable values, which represent any two input variables for an critic model C(ψ, ψ′).

In S420, an embedding module NNP is used to transform two input variables ψ and ψ′ into low-dimensional real-valued vectors. It is preferable to use a common embedding module NNP to ensure consistent conversion of any two input variables ψ and ψ′ into the same feature space. The structure of the embedding module NNp is not limited to a specific format. It may be implemented in various formats such as multi-layer perception (MLP), convolutional neural network (CNN), or transformer.

S430 represents values converted using the embedding module NN_{φ}. φ(ψ) and φ(ψ′) are defined as follows.

$$ϕ ( ψ ) = {NN}_{ϕ} ( ψ ) , ϕ ( {ψ}^{′} ) = {NN}_{ϕ} ( {ψ}^{′} )$$

S440 represents the composition of feature vectors h(ψ,ψ′) and h(ψ′, ψ). For example, the feature vectors may be composed as follows:

$$h ( ψ , {ψ}^{′} ) = ϕ ( ψ ) - ϕ ( {ψ}^{′} ) , h ( {ψ}^{′} , ψ ) = ϕ ( {ψ}^{′} ) - ϕ ( ψ )$$

$$h ( ψ , {ψ}^{′} ) = [ ϕ ( ψ ) , ϕ ( {ψ}^{′} ) ] , h ( {ψ}^{′} , ψ ) = [ ϕ ( {ψ}^{′} ) , ϕ ( ψ ) ] ; or$$

$$h ( ψ , {ψ}^{′} ) = [ ϕ ( ψ ) , ϕ ( {ψ}^{′} ) , ϕ ( ψ ) - ϕ ( {ψ}^{′} ) ] ,$$

$$h ( {ψ}^{′} , ψ ) = [ ϕ ( {ψ}^{′} ) , ϕ ( ψ ) , ϕ ( {ψ}^{′} ) - ϕ ( ψ ) ] .$$

Here, [φ(ψ′), φ(ψ)] means that two embedding vectors are concatenated to compose one vector.

S450 represents the feature vectors composed in the previous step.

In S460, an output module NN_{g} is used to calculate output values from the feature vectors h(ψ, ψ′) and h(ψ′, ψ). The structure of the output module NN_{g} is not limited to a specific format. It may be implemented in various formats such as multi-layer perception (MLP), convolutional neural network (CNN), or transformer.

S470 represents values calculated using the output module NN_{g}. g(ψ, ψ′) and g(ψ′, ψ) are defined as follows.

$$g ( ψ , {ψ}^{′} ) = N {N}_{g} ( h ( ψ , {ψ}^{′} ) ) , g ( {ψ}^{′} , ψ ) = N {N}_{g} ( h ( {ψ}^{′} , ψ ) )$$

In S480, a final evaluation comparison value C(ψ, ψ′) is calculated. C(ψ, ψ′) is defined as follows.

$$C ( ψ , {ψ}^{′} ) = g ( h ( ψ , {ψ}^{′} ) ) - g ( h ( {ψ}^{′} , ψ ) )$$

The critic model C(ψ, ψ′), which is constructed in the abovementioned format, has anti-symmetric properties. For example, for the case where the first feature vector composition method in S440 is used, it may be proven as in the following Equation 10.

$$\begin{matrix}C ( ψ , {ψ}^{′} ) = g ( h ( ψ , {ψ}^{′} ) ) - g ( h ( {ψ}^{′} , ψ ) ) \\ = g ( ϕ ( ψ ) - ϕ ( {ψ}^{′} ) ) - g ( ϕ ( {ψ}^{′} ) - ϕ ( ψ ) ) \\ = - \{ g ( ϕ ( {ψ}^{′} ) - ϕ ( ψ ) ) - g ( ϕ ( ψ ) - ϕ ( {ψ}^{′} ) ) \} \\ = - \{ g ( h ( {ψ}^{′} , ψ ) ) - g ( h ( ψ , {ψ}^{′} ) ) \} \\ = - C ( {ψ}^{′} , ψ )\end{matrix} \qquad [ Equation 10 ]$$

In S315 of FIG. 3, a set of neighboring input variable values

$${\{ {ψ}_{i} \}}_{i = 1}^{N}$$

is generated about ψ₀. However, the higher the dimension of the input variable, the more values of neighboring input variables need to be generated. In other words, the value of N must increase.

There is also no guarantee that the values of the input variables will be generated in a meaningful direction of distribution.

Therefore, rather than generating

$${\{ {ψ}_{i} \}}_{i = 1}^{N}$$

about ψ₀, a set of neighboring input (or setting) variable values

$${\{ {ϕ}_{i} \}}_{i = 1}^{N}$$

is generated about the low-dimensional embedding vector φ(ψ₀) of ψ₀. Then,

$${\{ {ϕ}_{i} \}}_{i = 1}^{N}$$

is transformed into a vector

$${\{ {\tilde{ψ}}_{i} \}}_{i = 1}^{N}$$

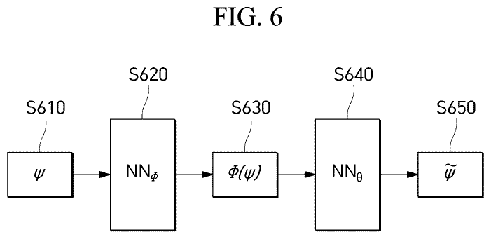

in the original input (or setting) variable space. For this purpose, a decoder module NN_{θ} as illustrated in FIG. 6 is configured.

FIG. 6 is a block diagram illustrating an operation of a decoder module according to an embodiment of the present disclosure.

In S610, ψ represents any input (or setting) variable value.

S620 represents an embedding module identical to the embedding module of S420 in FIG. 4.

In S630, φ(ψ) represents a value converted using the embedding module NN_{φ} and is identical to that of S430 in FIG. 4.

In S640, NNe represents a decoder module. The decoder module transforms embedding vectors into values in the original input (or setting) variable space.

S650 represents a recovered input (or setting) variable. In other words, \tilde{ψ} is defined as follows.

$${‖ ψ - {N}_{θ} ( ϕ ( ψ ) ) ‖}_{2}^{2}$$

The structure of the decoder module is not limited to a specific format. It may be implemented in various formats such as multi-layer perception (MLP), convolutional neural network (CNN), or transformer. For example, the decoder module may be trained to have a small squared Euclidean distance, i.e., to ensure that an original input (or setting) variable is well restored.

$${‖ ψ - {N}_{θ} ( ϕ ( ψ ) ) ‖}_{2}^{2}$$

In S320 of FIG. 3, ψ₀ and

$${\{ {\tilde{ψ}}_{i} \}}_{i = 1}^{N}$$

are used to drive the target system and obtain the result (or output) value

$${\{ {y}_{i} \}}_{i = 0}^{N} .$$

The reason why the average gradient is used in S350 of FIG. 3 is because safety increases.

The average gradient is used in order to reduce noise that may occur in gradient calculation and to provide a stable update direction. This may be explained mathematically as follows.

Each

$${∇}_{ψ = {ψ}_{0}} C ( ψ , {ψ}^{′} = {ψ}_{j}^{′} )$$

may be expressed as follows:

$${G}_{j} = {G}_{t rue} + {ϵ}_{j}$$

where

$${G}_{j} = {∇}_{ψ = {ψ}_{0}} C ( ψ , {ψ}^{′} = {ψ}_{j}^{′} )$$

individual gradient;
Gₜᵣᵤₑ: gradient of real

$$Δ R ( ψ , {ψ}^{′} = {ψ}_{j}^{′} )$$

or R(ψ) without noise:

$${G}_{true} = {∇}_{ψ = {ψ}_{0}} Δ R ( ψ , {ψ}^{′} = {ψ}_{j}^{′} ) = {∇}_{ψ = {ψ}_{0}} ( R ( ψ ) - R ( {ψ}^{′} = {ψ}_{j}^{′} ) ) = {∇}_{ψ = {ψ}_{0}} R ( ψ ) ;$$

and
ϵⱼ: noise vector generated during sampling and calculation. The following characteristics may be assumed:
the mean of the noise is 0: E[ϵⱼ]=0;
the noise has the same average magnitude:

$$E [ {‖ {ϵ}_{j} ‖}_{2}^{2} ] = {σ}_{ϵ}^{2} ;$$

and
noise from different variables is uncorrelated: Cov(ϵⱼ, ϵₖ)=0, j≠k.

The average (expectation) E[G] of the average gradient

$$G = \frac{1}{M} {\sum }_{j = 1}^{M}$$

Gⱼ is as follows.

$$\begin{matrix}E [ G ] = E [ \frac{1}{M} {\sum }_{j = 1}^{M} {G}_{j} ] \\ = E [ \frac{1}{M} {\sum }_{j = 1}^{M} {G}_{true} + {ϵ}_{j} ] \\ = \frac{1}{M} {\sum }_{j = 1}^{M} E [ {G}_{true} ] + \frac{1}{M} {\sum }_{j = 1}^{M} E [ {ϵ}_{j} ] \\ = \frac{1}{M} {\sum }_{j = 1}^{M} {G}_{true} + \frac{1}{M} {\sum }_{j = 1}^{M} 0 = {G}_{true}\end{matrix}$$

This means that the bias error of the average gradient G is 0.

$$Bias ( G ) = E [ G ] - {G}_{true} = 0$$

The variance error Var[G] of the average gradient G is as follows.

$$\begin{matrix}Var [ G ] = E [ {‖ G - {G}_{true} ‖}_{2}^{2} ] \\ = E [ {‖ \frac{1}{M} {\sum }_{j = 1}^{M} ( {G}_{j} - {G}_{true} ) ‖}_{2}^{2} ] \\ = E [ {‖ \frac{1}{M} {\sum }_{j = 1 j}^{M} {ϵ}_{j} ‖}_{2}^{2} ] \\ = \frac{1}{{M}^{2}} {\sum }_{j = 1}^{M} E [ {‖ {ϵ}_{j} ‖}_{2}^{2} ] \\ = \frac{1}{M} {σ}_{ϵ}^{2}\end{matrix}$$

However, the variance error of any single gradient Gⱼ is

$${σ}_{ϵ}^{2} .$$

$$Var [ {G}_{j} ] = E [ {‖ {G}_{j} - {G}_{true} ‖}_{2}^{2} ] = E [ {‖ {G}_{j} - {G}_{true} ‖}_{2}^{2} ] = E [ {‖ {ϵ}_{j} ‖}_{2}^{2} ] = {σ}_{ϵ}^{2}$$

In other words, it can be seen that the average gradient is used so that as the value of M in the average gradient increases, the variance error becomes smaller compared to the single gradient. Therefore, using the average gradient G increases the stability of the update direction and reduces excessive vibration or instability during optimization. It is noteworthy here that if using a critic model C(ψ)≈R(ψ) to predict the absolute evaluation value of a single variable, how to generate multiple gradients in ψ₀ is not obvious.

On the other hand, if the input variable is discrete, has structured characteristics, or is a symbolic expression, it may be difficult to apply the sampling method in S315 of FIG. 3. In this case, a set of neighboring input variable values

$${\{ {ϕ}_{i} \}}_{i = 1}^{N}$$

may be generated in the embedding space.

It may also be difficult to directly apply the gradient calculation of S345 and the ψ₀ update process of S350 in FIG. 3. In this case, it is appropriate to use the embedding vector φ((ψ₀) of ψ₀. The present disclosure is not limited to a specific embedding method.

If the input variable is discrete, has structured characteristics, or is a symbolic expression, the gradient calculation process of S345 and the update process of S350 may be modified as follows. For convenience of description, the critic model C(ψ, ψ′) is expressed as follows.

$$C ( ϕ ( ψ ) , ϕ ( {ψ}^{′} ) )$$

Here, φ(ψ) and φ(ψ′) are the output values of the embedding module NN_{φ}, which represent the embedding vectors of the input variables ψ and ψ′. The new expression simply changes the perspective of whether the inputs to the critic model are viewed as the original input variables ψ and ψ′ or as the embedding vectors φ(ψ) and φ(ψ′).

These expression changes do not deviate from the abovementioned principles, and the disclosure may be flexibly applied due to the abovementioned expression changes. The gradient is not calculated based on the input variable value ψ₀, but rather based on the embedding vector as follows.

$${\{ {∇}_{ϕ ( ψ ) = ϕ ( {ψ}_{0} )} C ( ϕ ( ψ ) , ϕ ( {ψ}^{′} ) = ( β ( {ψ}_{j}^{′} ) ) \}}_{j = 1}^{M}$$

The value of the variable φ(ψ′) corresponding to the second input of the critic model C(φ(ψ), φ(ψ′)) is set to

$${\{ ϕ ( {ψ}_{j}^{′} ) \}}_{j = 1}^{M} ,$$

and the critic model

$$C ( ϕ ( ψ ) , ϕ ( {ψ}^{′} ) = ϕ ( {ψ}_{j}^{′} ) )$$

is differentiated based on the first input variable φ(ψ). Then, the gradient

$${∇}_{ϕ ( ψ ) = ϕ ( {ψ}_{0} )} C ( ϕ ( ψ ) , ϕ ( {ψ}^{′} ) = ϕ ( {ψ}_{j}^{′} ) )$$

in φ(ψ₀) is calculated. This allows for acquisition of information that is able to adjust φ(ψ₀). If the value ψ₀ in the original input (or setting) variable space is required, the decoding module NN_{θ} described above may be used for restoration.

In a similar manner as described in S350, φ(ψ₀) is updated.

Gradient Descent: if the smaller the evaluation value R(ψ), the better, the value of φ(ψ₀) is updated by the stochastic gradient descent as follows:

$$ϕ ( {ψ}_{0} ) ← ϕ ( {ψ}_{0} ) - α \frac{1}{M} {\sum }_{j = 1}^{M} {∇}_{ϕ ( ψ ) = ϕ ( {ψ}_{0} )} C ( ϕ ( ψ ) , ϕ ( {ψ}^{′} ) = ϕ ( {ψ}_{j}^{′} ) )$$

where, α represents a learning rate,

$$\frac{1}{M} {\sum }_{j = 1}^{M} {∇}_{ϕ ( ψ ) = ϕ ( {ψ}_{0} )} C ( ϕ ( ψ ) , ϕ ( {ψ}^{′} ) = ϕ ( {ψ}_{j}^{′} ) )$$

represents an average gradient calculated using the surrounding value

$${\{ ϕ ( {ψ}_{j}^{′} ) \}}_{j = 1}^{M} of ϕ ( {ψ}_{0} ) .$$

Gradient Ascent: if the larger the evaluation value R(ψ), the better, the value of φ(ψ₀) is updated by the stochastic gradient ascent as follows:

$$ϕ ( {ψ}_{0} ) ← ϕ ( {ψ}_{0} ) + α \frac{1}{M} {\sum }_{j = 1}^{M} {∇}_{ϕ ( ψ ) = ϕ ( {ψ}_{0} )} C ( ϕ ( ψ ) , ϕ ( {ψ}^{′} ) = ϕ ( {ψ}_{j}^{′} ) )$$

where α and

$$\frac{1}{M} {\sum }_{j = 1}^{M} {∇}_{ϕ ( ψ ) = ϕ ( {ψ}_{0} )} C ( ϕ ( ψ ) , ϕ ( {ψ}^{′} ) = ϕ ( {ψ}_{j}^{′} ) )$$

are applied in the same way as the gradient descent.

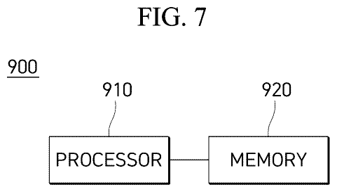

FIG. 7 is a diagram for explaining a computing environment including a computing device according to an embodiment of the present disclosure.

In the illustrated embodiment, individual components may have different functions and capabilities other than those described below, and may include additional components other than those described below. The illustrated computing environment includes a computing device 900, which may involve one or more components included in the optimization apparatus illustrated in FIG. 1.

The computing device 900 may include at least one processor 910 and a memory 920 that stores one or more programs executed by the at least one processor 910.

The processor 910 may cause the computing device 900 to operate according to the exemplary embodiments mentioned above. For example, the processor 910 may execute one or more programs stored in the computer-readable memory 920.

The one or more programs may include one or more computer-executable instructions, which may be configured to, when executed by the processor 910, cause the computing device 900 to perform operations according to the exemplary embodiments.

As described above, the method and apparatus for black-box optimization using dual critic models according to the embodiments of the present disclosure can optimize the black box without creating surrogate models.

According to the embodiments of the present disclosure, it is possible to reduce learning costs and error accumulation by learning only relative evaluation without modeling complex systems.

According to the embodiments of the present disclosure, it is possible to efficiently search for input (or setting) variables even in the high-dimensional input space due to embedding-based sampling and gradient-based updating.

According to the embodiments of the present disclosure, it is possible to eliminate common bias and secure prediction stability through relative value prediction rather than absolute value prediction.

According to the embodiments of the present disclosure, various inputs can be processed such as continuous, discrete, structured, and symbolic inputs.

The various technologies described herein may be implemented in digital electronic circuitry, or in computer hardware, firmware, software, or in combination of them. These technologies may implemented as a computer program product, i.e., a computer program tangibly embodied in an information carrier such as a machine-readable storage medium (computer-readable medium), for processing by, or to control the operation of, data processing devices, e.g., a programmable processor, a computer, or multiple computers. A computer program, such as the computer program(s) described above, may be written in any form of programming language, including compiled or interpreted languages, and may be deployed in any form, including as a standalone program or as a module, component, subroutine, or other unit suitable for use in a computing environment. A computer program may be deployed to be processed on one computer or multiple computers at one site or distributed across multiple sites and interconnected by a communication network.

Processors suitable for processing computer programs include, by way of example, both general-purpose and special-purpose microprocessors, and any one or more processors of any kind of digital computer. A processor will typically receive instructions and data from read-only memory, random access memory, or both. Elements of a computer may include may include at least one processor for executing instructions and one or more memory devices for storing instructions and data. Generally, a computer may also include, or be coupled to receive data from or transmit data to, or both, one or more mass storage devices for storing data, e.g., magnetic, magneto-optical disks, or optical disks. Examples of information carriers suitable for embodying computer program instructions and data include semiconductor memory devices, e.g., magnetic media such as hard disks, floppy disks, and magnetic tapes, optical media such as compact disk read-only memory (CD-ROM) and digital video disk (DVD), magneto-optical media such as floptical disks, read-only memory (ROM), random access memory (RAM), flash memory, erasable programmable ROM (EPROM), electrically erasable programmable ROM (EEPROM), etc. The processor and memory may be supplemented by, or incorporated in, special-purpose logic circuitry.

In addition, the computer-readable medium may be any available medium that is accessible by a computer, and may include both computer storage media and transmission media.

While this specification contains details of a number of specific implementations, these should not be understood as limitations on the scope of any disclosure or what is claimable, but rather as explanation of features that may be unique to particular embodiments of particular disclosures. Certain features described herein in the context of individual embodiments may also be implemented in combination in a single embodiment. Conversely, various features described in the context of a single embodiment may also be implemented in multiple embodiments, either individually or in any suitable subcombination. Furthermore, although the features may operate in a particular combination and may be initially depicted as being claimed as such, one or more features from a claimed combination may in some cases be excluded from that combination, and the claimed combination may be modified into a subcombination or a variation of a subcombination.

Likewise, although it depicts operations in the drawings in a particular order, it should not be understood as requiring that those operations be performed in the particular order depicted or in any sequential order to achieve a desirable result, or that all depicted operations be performed. In certain cases, multitasking and parallel processing may be advantageous. Additionally, the separation of various device components in the embodiments described above should not be understood as requiring such separation in all embodiments, and it should be understood that the described program components and devices may generally be integrated together into a single software product or packaged into multiple software products.

As is apparent from the above description, the method and apparatus for black-box optimization using dual critic models according to the embodiments of the present disclosure can optimize the black box without creating surrogate models.

According to the embodiments of the present disclosure, it is possible to reduce learning costs and error accumulation by learning only relative evaluation without modeling complex systems.

According to the embodiments of the present disclosure, it is possible to efficiently search for input (or setting) variables even in the high-dimensional input space due to embedding-based sampling and gradient-based updating.

According to the embodiments of the present disclosure, it is possible to eliminate common bias and secure prediction stability through relative value prediction rather than absolute value prediction.

According to the embodiments of the present disclosure, various inputs can be processed such as continuous, discrete, structured, and symbolic inputs.

Meanwhile, the embodiments disclosed in this specification and drawings are merely specific examples for the purpose of facilitating the understanding of the present disclosure, and are not intended to limit the scope of the present disclosure. It will be apparent to those skilled in the art that other modifications based on the technical idea of the present disclosure are possible in addition to the embodiments disclosed herein.

What is claimed is:

1. A method for black-box optimization, which is intended to optimize a target system in the form of a black box, comprising:
storing a data set composed of pairs of input variable values and evaluation values for the input variable values (ψ, R(ψ));
configuring a training data pair ((ψ,ψ′),ΔR(ψ, ψ′)) that represents a relative evaluation difference ΔR(ψ,ψ′) between a reference input variable value ψ and a selected input variable value ψ′ (which is different from the reference input variable value) in the data set;
training a differentiable dual critic model C(ψ, ψ′) that predicts a relative difference in evaluation value between two input variable values using the training data pair ((ψ, ψ′), ΔR(ψ, ψ′));
calculating a gradient for the reference input variable value ψ using the trained dual critic model; and
updating the reference input variable value ψ using the calculated gradient.

2. The method according to claim 1, wherein the target system in the form of a black box comprises at least one of:
a system whose internal structure or operating principle is not disclosed;
a system that is not able to directly calculate a differential value or internal gradient with respect to an input value;
a system that is able to only observe an output value according to an input value; and
a system that is any one of a function, a simulation model, a deep learning process, a chemical process system, and a physical system.

3. The method according to claim 2, further comprising:
generating a set of neighboring input variable values
$${\{ {ψ}_{i} \}}_{i = 1}^{N}$$
based on the reference input variable value ψ, wherein N represents the number of neighboring input variable values generated;
obtaining each output value
$${\{ {y}_{i} \}}_{i = 0}^{N}$$
by entering the neighboring input variable values
$${\{ {ψ}_{i} \}}_{i = 1}^{N}$$
of ψ into the target system; and
calculating an evaluation value
$${\{ R ( {ψ}_{i} ) \}}_{i = 0}^{N}$$
corresponding to each input variable value by entering the output value
$${\{ {y}_{i} \}}_{i = 0}^{N}$$
into an evaluation function R(·).

4. The method according to claim 3, wherein the calculating a gradient for the reference input variable value ψ comprises differentiating the dual critic model C(ψ, ψ′) with respect to ψ.

5. The method according to claim 4, wherein the calculating a gradient for the reference input variable value ψ, further comprises:
calculating M gradients, the number of which is the number of selected input variable values ψ′; and
calculating a final gradient using an average of the M gradients.

6. The method according to claim 3, wherein the dual critic model satisfies C(ψ, ψ′)=−C(ψ′, ψ).

7. The method according to claim 6, wherein the selected input variable value ψ′ satisfies
$$d ( ψ , {ψ}_{i}^{′} ) < {ϵ}_{ψ} ,$$
where the d is a measure of the distance between vectors and the ϵ_{ψ} is a user-set threshold value.

8. The method according to claim 6, wherein the selected input variable value ψ′ satisfies
$$d ( R ( ψ ) , ( {ψ}_{i}^{′} ) ) < {ϵ}_{R} ,$$
where the d is a measure of the distance between vectors and the ϵ_{R} is a user-set threshold value.

9. The method according to claim 3, wherein the set of neighboring input variable values
$${\{ {ψ}_{i} \}}_{i = 1}^{N}$$
is generated in an embedding space.

10. An apparatus for black-box optimization, which is intended to optimize a target system in the form of a black box, comprising:
a data storage unit configured to store a data set composed of pairs of input variable values and evaluation values for the input variable values (ψ, R(ψ));
a training data configuration unit configured to configure a training data pair ((ψ, ψ′), ΔR(ψ, ψ′)) that represents a relative evaluation difference ΔR(ψ, ψ′) between a reference input variable value ψ and a selected input variable value ψ′ (which is different from the reference input variable value) in the data set;
a training unit configured to train a differentiable dual critic model that predicts a relative difference in evaluation value between two input variable values using the training data pair;
a gradient calculation unit configured to calculate a gradient for the reference input variable value p using the trained dual critic model;
an input variable update unit configured to update the reference input variable value ψ using the calculated gradient; and
a control unit configured to control the data storage unit, the training data configuration unit, the gradient calculation unit, and the input variable update unit.

11. The apparatus according to claim 10, wherein the target system in the form of a black box comprises at least one of:
a system whose internal structure or operating principle is not disclosed;
a system that is not able to directly calculate a differential value or internal gradient with respect to an input value;
a system that is able to only observe an output value according to an input value; and
a system that is any one of a function, a simulation model, a deep learning process, a chemical process system, and a physical system.

12. The apparatus according to claim 11, further comprising:
a neighboring input variable generation module configured to generate a set of neighboring input variable values
$${\{ {ψ}_{i} \}}_{i = 1}^{N}$$
based on the reference input variable value ψ, wherein N represents the number of neighboring input variable values generated;
an output value acquisition unit configured to obtain each output value
$${\{ {y}_{i} \}}_{i = 0}^{N}$$
by entering the neighboring input variable values
$${\{ {ψ}_{i} \}}_{i = 1}^{N}$$
of ψ into the target system; and
an evaluation value calculation unit configured to calculate an evaluation value
$${\{ R ( {ψ}_{i} ) \}}_{i = 0}^{N}$$
corresponding to each input variable value by entering the output value
$${\{ {y}_{i} \}}_{i = 0}^{N}$$
into an evaluation function R(·).

13. The apparatus according to claim 12, wherein the gradient calculation unit differentiates the dual critic model C(ψ, ψ′) with respect to ψ.

14. The apparatus according to claim 13, wherein the gradient calculation unit is configured to:
calculate M gradients, the number of which is the number of selected input variable values ψ′; and
calculate a final gradient using an average of the M gradients.

15. The apparatus according to claim 12, wherein the dual critic model satisfies C(ψ, ψ′)=−C(ψ′, ψ).

16. The apparatus according to claim 15, wherein the selected input variable value ψ′ satisfies
$$d ( ψ , {ψ}_{i}^{′} ) < {ϵ}_{ψ} ,$$
where the d is a measure of the distance between vectors and the ϵ_{ψ} is a user-set threshold value.

17. The apparatus according to claim 15, wherein the selected input variable value ψ′ satisfies
$$d ( R ( ψ ) , R ( {ψ}_{i}^{′} ) ) < {ϵ}_{R} ,$$
where the d is a measure of the distance between vectors and the ϵ_{R} is a user-set threshold value.

18. The apparatus according to claim 12, wherein the set of neighboring input variable values
$${\{ {ψ}_{i} \}}_{i = 1}^{N}$$
is generated in an embedding space.

19. A computer-readable recording medium having a program stored thereon for causing a computer to execute a method for black-box optimization, the method for black-box optimization comprising:
storing a data set composed of pairs of input variable values and evaluation values for the input variable values (ψ, R(ψ));
configuring a training data pair ((ψ, ψ′),ΔR(ψ, ψ′)) that represents a relative evaluation difference ΔR(ψ,ψ′) between a reference input variable value ψ and a selected input variable value ψ′ (which is different from the reference input variable value) in the data set;
training a differentiable dual critic model that predicts a relative difference in evaluation value between two input variable values using the training data pair;
calculating a gradient for the reference input variable value ψ using the trained dual critic model; and
updating the reference input variable value ψ using the calculated gradient.

20. The computer-readable recording medium according to claim 19, wherein the method for black-box optimization further comprises:
generating a set of neighboring input variable values
$${\{ {ψ}_{i} \}}_{i = 1}^{N}$$
based on the reference input variable value ψ, wherein N represents the number of neighboring input variable values generated;
obtaining each output value
$${\{ {y}_{i} \}}_{i = 0}^{N}$$
by entering the neighboring input variable values
$${\{ {ψ}_{i} \}}_{i = 1}^{N}$$
of ψ into the target system; and
calculating an evaluation value
$${\{ R ( {ψ}_{i} ) \}}_{i = 0}^{N}$$
corresponding to each input variable value by entering the output value
$${\{ {y}_{i} \}}_{i = 0}^{N}$$
into an evaluation function R(·).
